(19) United States
(12) Patent Application Publication
(10) Pub. No.: US 2018/0267347 A1
(43) Pub. Date: Sep. 20, 2018

(54) LIQUID CRYSTAL DEVICE AND ELECTRONIC DEVICE

(71) Applicant: SEIKO EPSON CORPORATION, Tokyo (JP)

(72) Inventor: Nobutaka TANAKA, Shiojiri-shi (JP)

(73) Assignee: SEIKO EPSON CORPORATION, Tokyo (JP)

(21) Appl. No.: 15/909,201

(22) Filed: Mar. 1, 2018

(30) Foreign Application Priority Data
Mar. 14, 2017 (JP) 2017-048370

(51) Int. Cl. G02F 1/1337; G02F 1/1343; G02F 1/1335; G02F 1/1339

(52) U.S. Cl. CPC G02F 1/1337; G02F 1/1339; G02F 1/133512; G02F 1/134309

(57) ABSTRACT

In a liquid crystal device, a peripheral electrode is disposed in a peripheral region of a first substrate between a display region and a sealing member. Application of a proper voltage between the peripheral electrode and a common electrode causes ionic impurities to stay outside the display region. In the display region, an organic silane compound layer is disposed on a surface of a first alignment film, which is formed of an inorganic alignment film, adjacent to a liquid crystal layer, but the first alignment film and the organic silane compound layer are not formed in a region overlapping the peripheral electrode in plan view. Thus, the surface of the first substrate adjacent to the liquid crystal layer has higher hydrophilicity at the region overlapping the peripheral electrode than at the display region.

### BACKGROUND

### 1. Technical Field

The present invention relates to a liquid crystal device including an inorganic alignment film on a substrate, and an electronic device including the liquid crystal device.

### 2. Related Art

A liquid crystal device includes a first substrate having a pixel electrode in a display region, a second substrate having a common electrode facing the pixel electrode, a sealing member connecting the first substrate and the second substrate to each other, and a liquid crystal layer between the first substrate and the second substrate in a region surrounded by the sealing member. In the liquid crystal device, the orientation of liquid crystal molecules is changed when the liquid crystal device is powered on, generating a flow in the liquid crystal layer. This causes ionic impurities mixed during injection of liquid crystal or ionic impurities eluted from the sealing member to concentrate at a corner of the display region, for example, leading to image sticking (smear) or the like that deteriorates the display quality. To overcome the problem, JP-A-2013-257445 discloses a technique using a peripheral electrode for trapping ionic impurities. A peripheral electrode is disposed in a peripheral region between the display region and the sealing member to attract the ionic impurities to the region outside the display region and retain the ionic impurities there.

When an inorganic alignment film is used in a liquid crystal device, a Si atom with a dangling bond and a dimer structure (Si—Si bond) in which Si atoms are bonded together are present in the surface of the inorganic alignment film. The Si atom with a dangling bond is likely to be terminated with a silanol group (—Si—OH) by reaction with moisture or the like in the liquid crystals or the atmosphere. The silanol group is highly reactive. When the liquid crystal device is used as a light valve of a projection-type display device, for example, strong light is applied to the liquid crystal device, and photochemical reaction is likely to occur between the silanol group and the liquid crystal layer. Repetition of the photochemical reaction lowers a power of the inorganic alignment film to control the alignment of the liquid crystal molecules, gradually deteriorating the display performance of the liquid crystal device. To solve the problem, JP-A-2007-11226 discloses a technique using a silane coupling agent. The surface of the inorganic alignment film is treated with a silane coupling agent such that the hydroxyl group (—OH) moiety reacts to form an organic silane compound layer. This technique reduces the photochemical reaction between the silanol group and the liquid crystal layer.

### SUMMARY

However, the formation of the inorganic alignment film and the treatment with the silane coupling agent are performed over the entire surface of the first substrate. Thus, in the liquid crystal device in which the first substrate has the peripheral electrode for trapping the ionic impurities, the inorganic alignment film and the organic silane compound layer are formed on the surface of the peripheral electrode. This provides the surface of the peripheral electrode with water-repellent properties, decreasing the effect of attracting and retaining the ionic impurities.

An advantage of some aspects of the invention is that a liquid crystal device and an electronic device that are configured to effectively allow ionic impurities to stay outside the display region are provided.

A liquid crystal device includes a first substrate having a pixel electrode in a display region, a second substrate having a common electrode facing the pixel electrode, a sealing member connecting the first substrate and the second substrate to each other, a liquid crystal layer held between the first substrate and the second substrate in a region surrounded by the sealing member, a peripheral electrode disposed in a peripheral region between the display region of the first substrate and the sealing member, and an inorganic alignment film covering a surface of the pixel electrode adjacent to the liquid crystal layer. A surface of the first substrate adjacent to the liquid crystal layer has higher hydrophilicity at a region overlapping the peripheral electrode in plan view than at the display region.

In this configuration, since the peripheral electrode is disposed in the peripheral region between the display region of the first substrate and the sealing member, the peripheral electrode attracts ionic impurities and causes the ionic impurities to stay outside the display region. Furthermore, since the surface of the first substrate adjacent to the liquid crystal layer has higher hydrophilicity at the region overlapping the peripheral electrode in plan view than at the display region, the ionic impurities are efficiently attracted to the outside of the display region and allowed to stay there.

It is preferable that the first substrate include an organic silane compound layer on a surface of the inorganic alignment film adjacent to the liquid crystal layer. With this configuration, the silanol group or the like of the inorganic alignment film is not directly in contact with the liquid crystal layer. This reduces photochemical reaction between the silanol group or the like of the inorganic alignment film and the liquid crystal layer. In this case, the surface of the first substrate adjacent to the liquid crystal layer also has higher hydrophilicity at the region overlapping the peripheral electrode than at the display region. Thus, ionic impurities are efficiently attracted to the outside of the display region and allowed to stay there.

It is preferable that no organic silane compound layer be disposed in the region of the first substrate overlapping the peripheral electrode in plan view. With this configuration, the surface of the first substrate adjacent to the liquid crystal layer has higher hydrophilicity at the region overlapping the peripheral electrode in plan view than at the display region, although the organic silane compound layer has water-repellent properties.

It is preferable that no inorganic alignment film be disposed in the region of the first substrate overlapping the peripheral electrode in plan view. With this configuration, since the inorganic alignment film is not disposed in the region overlapping the peripheral electrode in plan view, an organic silane compound layer is unlikely to be formed in the region overlapping the peripheral electrode in plan view by treatment of the surface of the inorganic alignment film with a silane coupling agent, depending on the material of the peripheral electrode. Thus, the surface of the first substrate adjacent to the liquid crystal layer has higher hydrophilicity at the region overlapping the peripheral electrode than at the display region, although the organic silane compound layer has water-repellent properties.

It is preferable that a hydrophilized layer be disposed on the surface of the first substrate adjacent to the liquid crystal layer in the region overlapping the peripheral electrode in plan view. With this configuration, the surface of the first substrate adjacent to the liquid crystal layer has higher hydrophilicity at the region overlapping the peripheral electrode in plan view than at the display region.

It is preferable that, in the first substrate, the hydrophilized layer be disposed on a surface of the peripheral electrode adjacent to the liquid crystal layer.

It is preferable that the peripheral electrode and the pixel electrode be formed of different conductive films. This configuration expands the range of choices about the treatment agent for forming the hydrophilized layer. For example, the conductive film may be formed of a metal film including copper, silver, gold, platinum, or palladium as a main component, and the hydrophilized layer may include a thiol group bonded to the metal film.

It is preferable that the hydrophilized layer include an anionic hydrophilic group in a surface adjacent to the liquid crystal layer. With this configuration, cationic impurities such as sodium ion are adsorbed by the hydrophilized layer and allowed to stay outside the display region.

It is preferable that no hydrophilized layer be disposed in the display region of the first substrate. With this configuration, the hydrophilized layer does not prevent driving of the liquid crystal layer in the display region.

It is preferable that the inorganic alignment film and the organic silane compound layer be disposed on the first substrate in the region overlapping the peripheral electrode in plan view, and a portion of the organic silane compound layer in the region overlapping the peripheral electrode in plan view is a modified layer having lower water-repellent properties. With this configuration, the surface of the first substrate adjacent to the liquid crystal layer has higher hydrophilicity at the region overlapping the peripheral electrode than at the display region.

A liquid crystal device according to the invention may be used in various electronic devices such as a direct view display device or a projection-type display device. When the electronic device that uses the liquid crystal device is the projection-type display device, the projection-type display device includes a light source configured to output light to the liquid crystal device and a projection optical system configured to project the light modulated by the liquid crystal device.

### BRIEF DESCRIPTION OF THE DRAWINGS

The invention will be described with reference to the accompanying drawings, wherein like numbers reference like elements.

FIG. 1 is a plan view illustrating a configuration example of a liquid crystal device according to a first embodiment of the invention.

FIG. 2 is a cross-sectional view of the liquid crystal device illustrated in FIG. 1 taken along line II-II.

FIG. 3 is a cross-sectional view schematically illustrating a specific configuration example of a pixel of the liquid crystal device illustrated in FIG. 1.

FIG. 4 is an explanatory view illustrating a first alignment film and a second alignment film of the liquid crystal device illustrated in FIG. 1.

FIG. 5 is a cross-sectional view schematically illustrating components around the peripheral electrode illustrated in FIG. 2.

FIG. 6 is an explanatory view schematically illustrating a surface of the first alignment film and a surface of the peripheral electrode illustrated in FIG. 2.

FIG. 7 is a cross-sectional view schematically illustrating components around the peripheral electrode of a liquid crystal device according to a second embodiment of the invention.

FIG. 8 is a cross-sectional view schematically illustrating components around the peripheral electrode of a liquid crystal device according to a third embodiment of the invention.

FIG. 9 is a cross-sectional view schematically illustrating components around the peripheral electrode of a liquid crystal device according to a fourth embodiment of the invention.

FIG. 10 is an explanatory view illustrating a projection-type display device (an electronic device) including a liquid crystal device according to the invention.

### DESCRIPTION OF EXEMPLARY EMBODIMENTS

Embodiments of the invention are described with reference to the drawings. In the drawings used in the following description, different scales are used to illustrate layers and members such that the layers and the members are recognizable in the drawings. In the description of layers of a first substrate, an upper layer side or a top surface side means a side away from the substrate body of the first substrate (a side adjacent to a second substrate and an electro-optical layer) and a lower layer side means a side adjacent to the substrate body of the first substrate. In the description of layers of a second substrate, an upper layer side or a top surface side means a side away from the substrate body of the second substrate (a side adjacent to the first substrate and the electro-optical layer) and a lower surface side means a side adjacent to the substrate body of the second substrate.

In the following description, the configuration common to all the embodiments is described first, and then first, second, third, and fourth embodiments are described in this order. In the first, second, third, and fourth embodiments, components around a peripheral electrode 8a are as indicated in Table 1 below.

TABLE 1

| | Inorganic | | |
|---|---|---|---|
| | Alignment | Silane Coupling | |
| Components | Film (First | Treatment (Organic | |
| around Peripheral | Alignment | Silane Compound | Hydrophilized |
| Electrode 8a | Film 16) | Layer 17) | Layer 18 |
| First Embodiment | No | No | Yes |
| Second Embodiment | No | No | No |
| Third Embodiment | Yes | No | No |
| Fourth Embodiment | Yes | Yes (a modified | No |
| | | layer 17a) | |

### First Embodiment

### Overall Configuration of Liquid Crystal Device 100

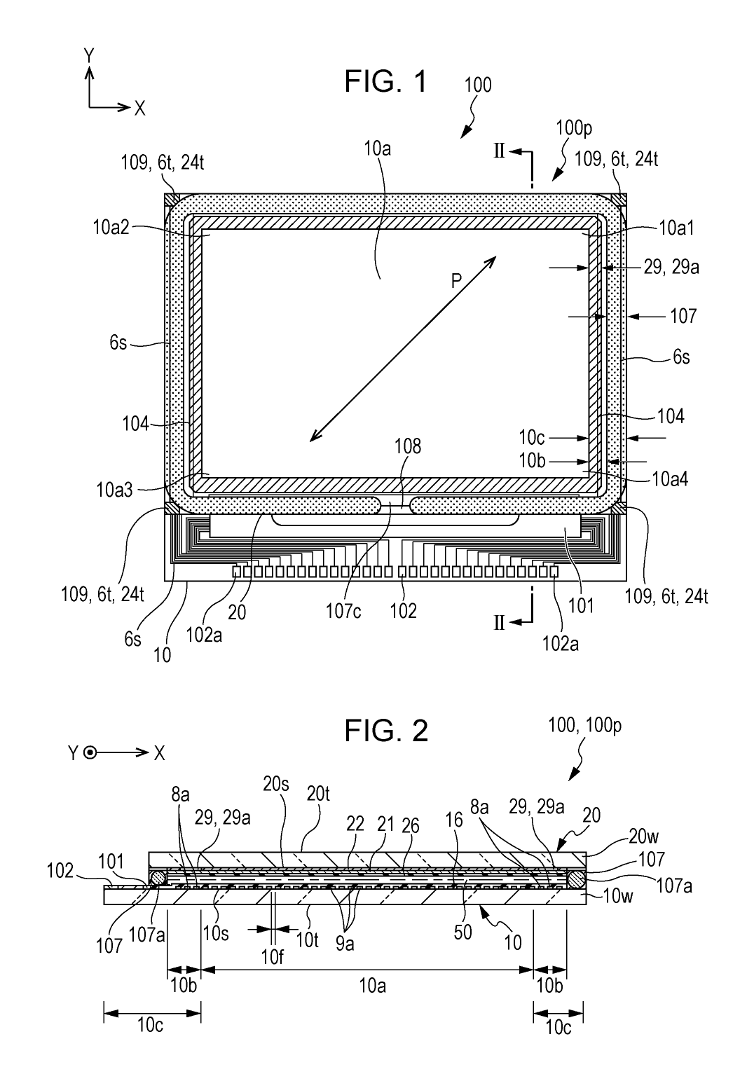

FIG. 1 is a plan view illustrating a configuration example of a liquid crystal device 100 according to a first embodiment of the invention. FIG. 2 is a cross-sectional view of the liquid crystal device 100 taken along line II-II in FIG. 1. The liquid crystal device 100 illustrated in FIG. 1 and FIG. 2 includes a liquid crystal panel 100p. In the liquid crystal device 100, a first substrate 10 (an element substrate) and a second substrate 20 (a counter substrate) are connected to each other by a sealing member 107 with a predetermined space therebetween. The sealing member 107 has a frame-like shape extending along the outer edge of the second substrate 20. The sealing member 107 is an adhesive formed of a light-curing resin or a thermal curing resin and contains a gap material 107a such as fiberglass, glass beads, or the like so as to maintain a predetermined distance between the first substrate 10 and the second substrate 20. The liquid crystal panel 100p includes a liquid crystal layer 50 between the first substrate 10 and the second substrate 20 in a region surrounded by the sealing member 107. The sealing member 107 has a discontinuous portion 107c used as a liquid crystal injection port. The discontinuous portion 107c is sealed by a sealing substance 108 after injection of liquid crystal. The sealing member 107 does not have the discontinues portion 107c when the liquid crystal is added dropwise.

In the liquid crystal panel 100p, the first and second substrates 10 and 20 are rectangular. The liquid crystal panel 100p has a rectangular display region 10a at the substantially middle. The sealing member 107 is formed in a substantially rectangular shape so as to correspond to the shape of the display region 10a. The region outside the display region 10a is an outer region 10c having a rectangular frame-like shape.

In the outer region 10c (a region having a rectangular frame-like shape outside the display region 10a) of the first substrate 10, a data line driving circuit 101 and a plurality of terminals 102 are disposed on a protruded portion, which protrudes from the second substrate 20, along one side of the first substrate 10. A scanning line driving circuit 104 is disposed along another side of the first substrate 10 adjacent to the one side. The terminals 102 are located on the outer side of the sealing member 107. A flexible wiring board (not illustrated) is connected to the terminals 102 such that potentials and signals are sent to the first substrate 10 through the flexible wiring board. In this embodiment, the data line driving circuit 101 and the scanning line driving circuit 104 partly overlap the sealing member 107 in plan view.

The first substrate 10 includes a light-transmitting substrate body 10w such as a quartz substrate or a glass substrate. The first substrate 10 (the substrate body 10w) has a first surface 10s facing the second substrate 20 and a second surface 10t opposite the first surface 10s. A plurality of pixel switching elements and pixel electrodes 9a electrically connected to the respective pixel switching elements are arranged in a matrix in the display region 10a on the first surface 10s. A first alignment film 16 is disposed on the upper layer side of the pixel electrodes 9a.

On the first surface 10s of the substrate body 10w of the first substrate 10, peripheral electrodes 8a for trapping ionic impurities are disposed in a rectangular frame shaped peripheral region 10b between the display region 10a and the sealing member 107 of the outer region 10c outside the display region 10a. In the peripheral region 10b, dummy pixel electrodes may be formed between the pixel electrodes 9a and the peripheral electrodes 8a at the same time as the formation of the pixel electrodes 9a. In FIG. 2, two lines of the peripheral electrodes 8a are provided along each side, but one or three lines of the peripheral electrodes 8a may be provided along each side.

The second substrate 20 includes a light-transmitting substrate body 20w such as a quartz substrate and a glass substrate. The second substrate 20 (the substrate body 20w) has a first surface 20s facing the first substrate 10 and a second surface 20t opposite the first surface 20s. A common electrode 21 is disposed on the first surface 20s. The common electrode 21 is formed over the entire surface of the second substrate 20 or formed as a plurality of strip-shaped electrodes across the plurality of pixels 100a. In this embodiment, the common electrode 21 is formed over the substantially entire area of the second substrate 20. A light-shielding layer 29 is disposed on the first surface 20s of the substrate body 20w of the second substrate 20 on the lower layer side of the common electrode 21, and a second alignment film 26 is disposed on a surface of the common electrode 21 adjacent to the liquid crystal layer 50. A light-transmitting planarizing film 22 is disposed between the light-shielding layer 29 and the common electrode 21. The light-shielding layer 29 is formed as a frame-shaped portion 29a extending along the outer edge of the display region 10a. The light-shielding layer 29 may include black matrix portions (not illustrated) overlapping inter-pixel regions 10f between adjacent pixel electrodes 9a. The frame-shaped portion 29a overlaps the peripheral electrodes 8a in plan view.

In the liquid crystal panel 100p, inter-substrate conductive electrodes 24t are disposed on four corners of the first surface 20s of the substrate body 20w of the second substrate 20 outside the sealing member 107, and inter-substrate conductive electrodes 6t are disposed on the first surface 10s of the substrate body 10w of first substrate 10 at positions facing four corners of the second substrate 20 (the inter-substrate conductive electrodes 24t). The inter-substrate conductive electrodes 6t are electrically connected to a constant-potential wire 6s to which a common potential Vcom is applied. Of the terminals 102, the constant-potential wire 6s is electrically connected to a terminal 102a for applying the common potential. Inter-substrate conducting members 109 including conductive particles are disposed between the inter-substrate conductive electrodes 6t and the inter-substrate conductive electrodes 24t. The common electrode 21 of the second substrate 20 is electrically connected to the first substrate 10 through the inter-substrate conductive electrodes 6t, the inter-substrate conducting members 109, and the inter-substrate conductive electrodes 24t. Accordingly, the common potential Vcom is applied to the common electrode 21 from the side of the first substrate 10.

The liquid crystal device 100 of this embodiment is a light transmission type liquid crystal device. Thus, the pixel electrodes 9a and the common electrode 21 are each formed of a light-transmitting conductive film, such as an ITO (Indium Tin Oxide) film or an IZO (Indium Zinc Oxide) film. In the liquid crystal device 100 (the light transmission type liquid crystal device), light L applied from the side of the second substrate 20 is modulated before the light L exits through the first substrate 10, and an image is displayed. The common electrode 21 may be formed of a light-transmitting conductive film and reflective electrodes may be employed as the pixel electrodes 9a. In such a case, the liquid crystal device 100 is configured as a reflection type liquid crystal device. In the liquid crystal device 100 (the reflection type liquid crystal device), the light applied from the side of the second substrate 20 is reflected by the pixel electrodes 9a of the first substrate 10 and is modulated before the light L exits through the second substrate 20, and an image is displayed.

The liquid crystal device 100 may be used as a color display device of an electronic device, such as a mobile computer and a mobile telephone. In such a case, a color filter (not illustrated) is disposed on the first substrate 10 or the second substrate 20. The liquid crystal device 100 may be used as a light valve for RGB of a projection-type display device (a liquid crystal projector) described below. In such a case, light in each color separated by a dichroic mirror for RGB color separation is applied as projection light to the respective liquid crystal device for RGB 100. Thus, the liquid crystal devices 100 include no color filter.

### Specific Configuration of Pixel 100a

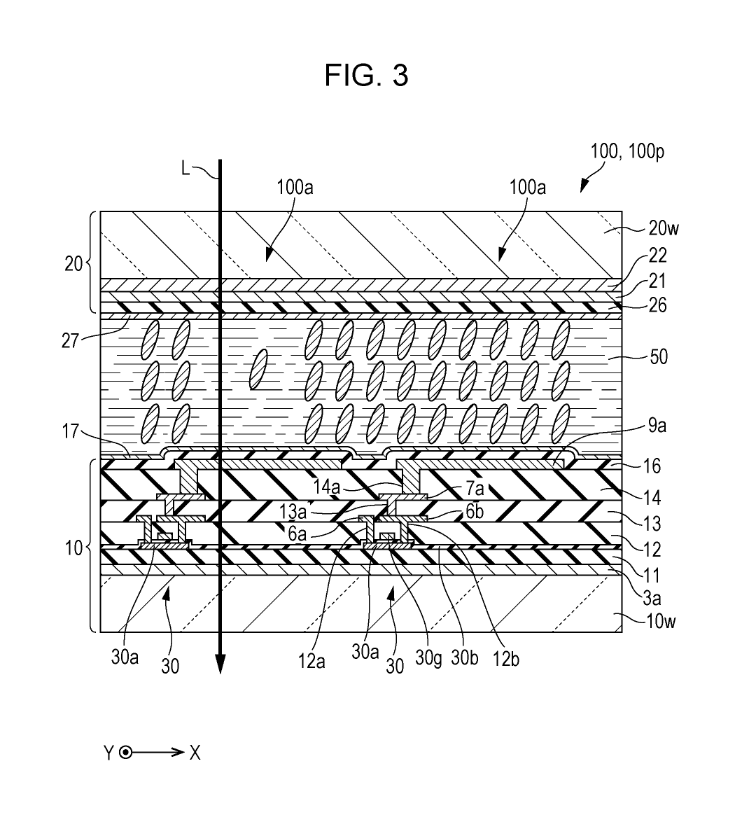

FIG. 3 is a cross-sectional view schematically illustrating a specific configuration example of the pixel 100a of the liquid crystal device 100 illustrated in FIG. 1. As illustrated in FIG. 3, a scanning line 3a formed of a conductive film, such as a conductive polysilicon film, a metallic silicide film, a metallic film, and a metallic compound film, is disposed on the substrate body 10w of the first surface 10s of the first substrate 10 at the lower layer side. In this embodiment, the scanning line 3a is formed of a light-shielding film, such as tungsten silicide (WSi). A light-transmitting insulating film 11 is formed on the upper layer side of the scanning line 3a. A pixel switching element 30 including a semiconducting layer 30a is disposed on a top surface of the insulating film 11. In this embodiment, the insulating film 11 is formed of a silicon oxide film or the like.

The pixel switching element 30 includes a semiconductor layer 30a, a gate electrode 30g intersecting the semiconductor layer 30a, and a light-transmitting gate insulating layer 30b between the semiconductor layer 30a and the gate electrode 30g. The semiconductor layer 30a is formed of a polysilicon film (a polycrystalline silicon film) or the like. The gate insulating layer 30b has a two-layered structure composed of a first gate insulating layer including a silicon oxide film formed by thermally oxidizing the semiconductor layer 30a and a second data insulating layer including a silicon oxide film formed by a low-pressure CVD method or the like. The gate electrode 30g is electrically connected through a contact hole (not illustrated) extending through the gate insulating layer 30b and the insulating film 11.

Light-transmitting inter-layer insulating films 12, 13, and 14 each formed of a silicon oxide film or the like are disposed in this order on the upper layer side of the gate electrode 30g. Storage capacitors (not illustrated) are provided by using spaces between the inter-layer insulating films 12, 13, and 14, for example. A data line 6a and a drain electrode 6b are provided between the inter-layer insulating film 12 and the inter-layer insulating film 13. A relay electrode 7a is provided between the inter-layer insulating film 13 and the inter-layer insulating film 14. The data line 6a is electrically connected to a source region of the semiconductor layer 30a through a contact hole 12a extending through the inter-layer insulating film 12 and the gate insulating layer 30b. The drain electrode 6b is electrically connected to a drain region of the semiconductor layer 30a through a contact hole 12b extending through the inter-layer insulating film 12 and the gate insulating layer 30b. The relay electrode 7a is electrically connected to the drain electrode 6b through a contact hole 13a extending through the inter-layer insulating film 13. The inter-layer insulating film 14 has a flat top surface. The pixel electrodes 9a are disposed on the top surface of the inter-layer insulating layer 14 (the surface adjacent to the liquid crystal layer 50). The pixel electrode 9a is electrically connected to the relay electrode 7a through a contact hole 14a extending through the inter-layer insulating film 14. Accordingly, the pixel electrode 9a is electrically connected to the drain region of the pixel switching element 30 through the relay electrode 7a and the drain electrode 6b.

### Configuration of First Alignment Film 16 and Second Alignment Film 26

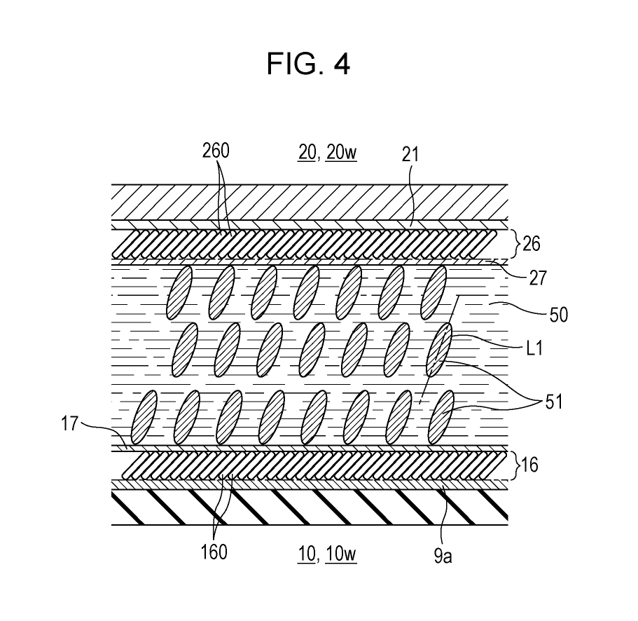

FIG. 4 is a magnified explanatory view illustrating the first alignment film 16 and the second alignment film 26 of the liquid crystal device 100 illustrated in FIG. 1. In FIG. 4, components on the lower layer side of the pixel electrode 9a are not illustrated.

In FIG. 4, the first and second alignment films 16 and 26 are inorganic alignment films each formed of an obliquely deposited film of a silicon oxide film (SiOₓ (x 2)), a titanium oxide film (TiO₂), a magnesium oxide film (MgO), or an aluminum oxide film (Al₂O₃). Thus, in the first and second alignment films 16 and 26, columns 160 and 260 are tilted against the normal direction to the first surfaces 10s and 20s of the first and second substrates 10 and 20. An alignment controlling force of the first alignment film 16 and that of the second alignment film 26 are antiparallel. Thus, as illustrated by a solid line L1, the first alignment film 16 and the second alignment film 26 cause nematic liquid crystal molecules (liquid crystal molecules 51) having negative dielectric anisotropy, which are included in the liquid crystal layer 50, to tilt with respect to the first and second substrates 20. This causes the liquid crystal molecules 51 to have a pretilt angle. In this way, the liquid crystal device 100 is configured as a liquid crystal device in a normally black VA mode. The liquid crystal molecules 51 located near the first substrate 10 are fixed to the first substrate 10 at one end of the molecular chain, and the liquid crystal molecules 51 located near the second substrate 20 are fixed to the second substrate 20 at one end of the molecular chain.

In this embodiment, as indicated by an arrow P in FIG. 1, when seen from the side of the first substrate 10, the pretilt direction of the liquid crystal molecules 51 is set to be a direction from a corner 10a1 of four corners 10a1 to 10a4 of the display region 10a toward the corner 10a3 and a direction from the corner 10a3 toward the corner 10al.

### Components Around Peripheral Electrode 8a

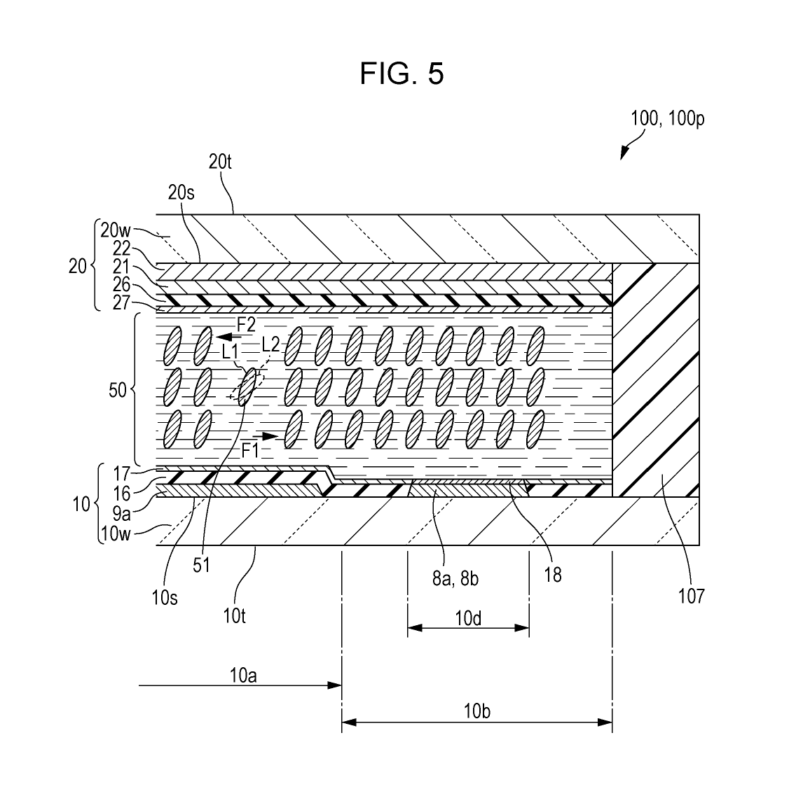

FIG. 5 is a cross-sectional view schematically illustrating components around the peripheral electrode 8a illustrated in FIG. 2. In FIG. 5, components on the lower layer side of the pixel electrode 9a are not illustrated. In FIG. 5, one peripheral electrode 8a is illustrated. When a frame inversion driving is employed in the liquid crystal device 100, a polarity of the pixel electrode 9a is inverted for each frame with an electric potential of the common electrode 21 being a reference. Thus, ionic impurities are repeatedly attached to the pixel electrodes 9a and detached from the pixel electrodes 9a in accordance with the polarity inversion of the pixel electrodes 9a. Furthermore, when the liquid crystal device 100 is driven, orientation of the liquid crystal molecules 51 in the liquid crystal layer 50 is changed as indicated by the solid line L1 and a dotted line L2 in FIG. 5. This generates, at positions near the first substrate 10 and the second substrate 20, a flow for causing ionic impurities to concentrate as indicated by an arrow F1 and an arrow F2. When the liquid crystal device 100 is inversely driven, a flow for causing ionic concentration of impurities is generated if unbalance occurs in a direct-current component.

In such a case, in the first substrate 10 of the embodiment, the peripheral electrode 8a in the peripheral region 10b faces the common electrode 21 with the liquid crystal layer 50 therebetween. Thus, application of a proper voltage to the peripheral electrode 8a causes the ionic impurities to concentrate and stay outside the display region 10a near the peripheral electrode 8a. For example, a voltage between the peripheral electrode 8a and the common electrode 21 is set higher than a voltage between the pixel electrode 9a and the common electrode 21. The ionic impurities may be cationic impurities such as sodium ion. In such a case, application of a lower voltage to the peripheral electrode 8a than to the common electrode 21 causes the ionic impurities to concentrate and stay outside the display region 10a near the peripheral electrode 8a. Furthermore, formation of an anionic hydrophilic group on a surface of the peripheral electrode 8a adjacent to the liquid crystal layer 50 causes cationic impurities such as sodium ion to be adsorbed to the anionic hydrophilic group and stay there without application of a voltage to the peripheral electrode 8a. This reduces deterioration in the display quality due to aggregation of the ionic impurities. The peripheral electrode 8a is disposed at least near the corner 10a1 and the corner 10a3 illustrated in FIG. 1. In this embodiment, the peripheral electrode 8a has a frame-like shape surrounding the entire display region 10a.

### Configurations of First Alignment Film 16 and Components Around Peripheral Electrode 8a

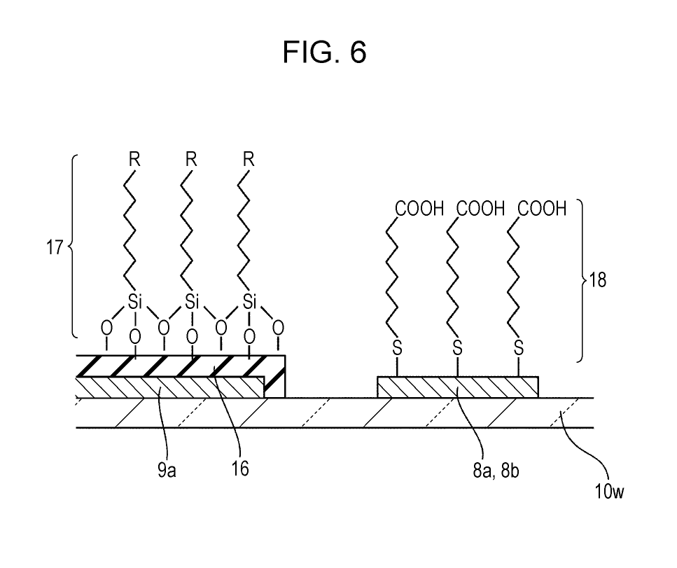

FIG. 6 is an explanatory view schematically illustrating a surface of the first alignment film 16 and a surface of the peripheral electrode 8a illustrated in FIG. 2. In this embodiment, as illustrated in FIG. 4 and FIG. 5, the organic silane compound layers 17 and 27 are respectively disposed on the surfaces of the first and second alignment films 16 and 26 adjacent to the liquid crystal layer 50. With this configuration, the silanol groups of the first and second alignment films 16 and 26 are not in contact with the liquid crystal layer 50. Thus, photochemical reaction is unlikely to occur between the silanol groups of the first and second alignment films 16 and 26 and the liquid crystal layer 50, improving the reliability of the liquid crystal device 100.

More specifically described, a Si atom with a dangling bond and a dimer structure (Si—Si bond) in which Si atoms are bonded together are present on the surface of the first alignment film 16. The Si atom with a dangling bond is likely to be terminated with a silanol group (—Si—OH) by reaction with moisture or the like in the liquid crystals or the atmosphere. The silanol group is highly reactive. Thus, in this embodiment, as illustrated in FIG. 6, the surface of the first alignment film 16 is treated with a silane coupling agent, such as organic siloxane (decyltrimethoxysilane) to form the organic silane compound layer 17 bonded to the hydroxyl group (—OH) moiety. Thus, the silanol group of the first alignment film 16 and the liquid crystal layer 50 are not in contact with each other.

The silane coupling agent used here is hydrolyzed to generate silanols (Si—OH), and then the silanols condense to generate a siloxane bond (Si—O—Si), forming the organic silane compound layer 17. The silane coupling agent forms a strong bond with an inorganic oxide surface of the first alignment film 16 or the like to form a self-assembled monolayer. Examples of the silane coupling agent include n-hexyltrimethoxysilane, n-hexyltriethoxysilane, cyclohexylmethyldimethoxysilane, n-octyltriethoxysilane, and n-decyltrimethoxysilane. Furthermore, the silane coupling agent may include a fluorine atom (F) at a hydrophobic organic functional group R. Any of the silane coupling agents provides the organic silane compound layer 17 with water-repellent properties by using. The organic silane compound layer 27 formed on the second alignment film 26 has the configuration similar to that of the organic silane compound layer 17.

In this embodiment, as described below with reference to FIG. 5 and FIG. 6, the surface of the first substrate 10 adjacent to the liquid crystal layer 50 has higher hydrophilicity at the region 10d overlapping the peripheral electrode 8a in plan view than at the display region 10a. More specifically described, the first alignment film 16 and the organic silane compound layer 17 are formed over the entire display region 10a, but are not formed in the region 10d overlapping the peripheral electrode 8a in plan view.

Furthermore, in the first substrate 10, a hydrophilized layer 18 is formed on the surface of the peripheral electrode 8a adjacent to the liquid crystal layer 50. In this embodiment, the peripheral electrode 8a is formed of a conductive film different from that of the pixel electrode 9a. The hydrophilized layer 18 is selectively formed on the surface of the peripheral electrode 8a adjacent to the liquid crystal layer 50. The hydrophilized layer 18 is not formed in the display region 10a.

In this embodiment, the peripheral electrode 8a is formed of a metal film 8b including copper, silver, gold, platinum, or palladium as a main component. As illustrated in FIG. 6, the hydrophilized layer 18 includes thiol groups bonded to the metal film 8b. Thus, contact of a processing liquid containing a hydrophilizing agent with the first substrate 10 causes the thiol groups of the hydrophilizing agent to selectively bond to the metal film 8b, forming a self-assembled monolayer. In addition, the hydrophilized layer 18 has an anionic hydrophilic group including a carboxyl group. Thus, the surface of the first substrate 10 adjacent to the liquid crystal layer 50 has higher hydrophilicity at the region 10d overlapping the peripheral electrode 8a in plan view than at the display region 10a. Furthermore, the anionic hydrophilic group such as a carboxyl group included in the hydrophilized layer 18 enables cationic impurities such as a sodium ion to be adsorbed thereto and to stay in the peripheral region 10b.

The above-described configuration is obtained by, for example, forming the first alignment film 16 and the organic silane compound layer 17 over the entire area of the first substrate 10 after formation of the pixel electrode 9a and the peripheral electrode 8a, and then removing the first alignment film 16 and the organic silane compound layer 17 from the peripheral region 10b. After the above, the first substrate 10 is brought into contact with the hydrophilizing liquid, and then the first substrate 10 is cleaned by using pure water or alcohol to form the hydrophilized layer 18 on the surface of the peripheral electrode 8a adjacent to the liquid crystal layer 50. The organic silane compound layer 17 and the hydrophilized layer 18 may be formed after the first alignment film 16 is formed over the entire surface of the first substrate 10 and the first alignment film 16 is removed from the peripheral region 10b.

### Main Effects of Embodiment

As described above, in the embodiment, the peripheral electrode 8a is disposed in the peripheral region 10b between the display region 10a of the first substrate 10 and the sealing member 107. In this configuration, the peripheral electrode 8a causes ionic impurities to stay outside the display region 10a. Furthermore, the surface of the first substrate 10 adjacent to the liquid crystal layer 50 has higher hydrophilicity at the region 10d overlapping the peripheral electrode 8a in plan view than at the display region 10a. With this configuration, the peripheral electrode 8a efficiently attracts the ionic impurities to the outside of the display region 10a and causes the ionic impurities to stay there.

In addition, in the embodiment, the organic silane compound layers 17 and 27 are respectively disposed on the surfaces of the inorganic alignment films (the first and second alignment films 16 and 26) adjacent to the liquid crystal layer 50. With this configuration, the silanol group or the like of the inorganic alignment films are not directly in contact with the liquid crystal layer 50. This reduces photochemical reaction between the silanol group or the like of the inorganic alignment film and the liquid crystal layer 50. In this case, the surface of the first substrate 10 adjacent to the liquid crystal layer 50 does not have the first alignment film 16 and the organic silane compound layer 17 in the region 10d overlapping the peripheral electrode 8a in plan view, allowing the region 10d overlapping the peripheral electrode 8a to have higher hydrophilicity than the display region 10a. Thus, ionic impurities are efficiently attracted to the outside of the display region 10a and allowed to stay there.

### Second Embodiment

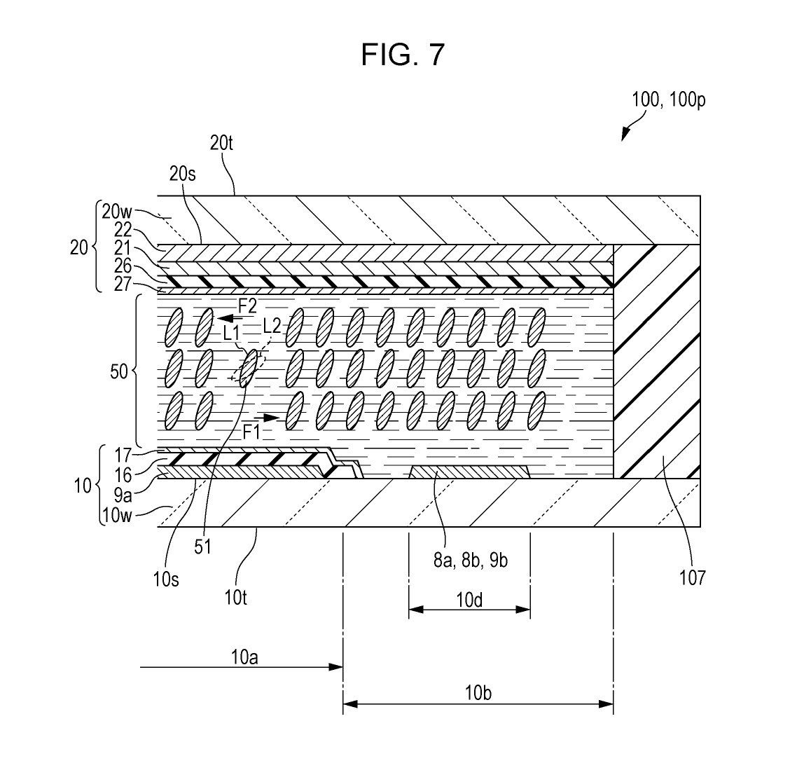

FIG. 7 is a cross-sectional view schematically illustrating components around the peripheral electrode 8a of a liquid crystal device 100 according to a second embodiment of the invention. The basic components of the second embodiment and third and fourth embodiments described below are the same as those of the first embodiment. Thus, identical reference numerals are used to denote identical components, and the components are not described in detail.

As illustrated in FIG. 7, in this embodiment, the first substrate 10 has the peripheral electrode 8a in the peripheral region 10b as in the first embodiment. In addition, the organic silane compound layers 17 and 27 are respectively disposed on the surfaces of the first and second alignment films 16 and 26 adjacent to the liquid crystal layer 50. Here, the first alignment film 16 and the organic silane compound layer 17 are disposed over the entire display region 10a, but are not disposed in the region 10d overlapping the peripheral electrode 8a in plan view. With this configuration, although the organic silane compound layers 17 and 27 are formed on the surfaces of the inorganic alignment films (the first and second alignment films 16 and 26) adjacent to the liquid crystal layer 50, the surface of the first substrate 10 adjacent to the liquid crystal layer 50 has higher hydrophilicity at the region 10d overlapping the peripheral electrode 8a in plan view than at the display region 10a. Thus, ionic impurities are attracted to the outside of the display region 10a by the peripheral electrode 8a and allowed to stay there. Such a configuration is obtained by, for example, forming the first alignment film 16 and the organic silane compound layer 17 over the entire surface of the first substrate 10, and then removing the first alignment film 16 and the organic silane compound layer 17 from the peripheral region 10b. Alternatively, the configuration may be obtained by forming the first alignment film 16 over the entire surface of the first substrate 10, removing the first alignment film 16 from the peripheral region 10b, and then forming the organic silane compound layer 17 in this order.

The peripheral electrode 8a is formed of a metal film 8b including copper, silver, gold, platinum, or palladium as a main component. It is to be noted that the second embodiment differs from the first embodiment in that the hydrophilized layer 18 is not formed. Thus, the peripheral electrode 8a may be a conductive film 9b formed at the same time as formation of the pixel electrode 9a.

### Third Embodiment

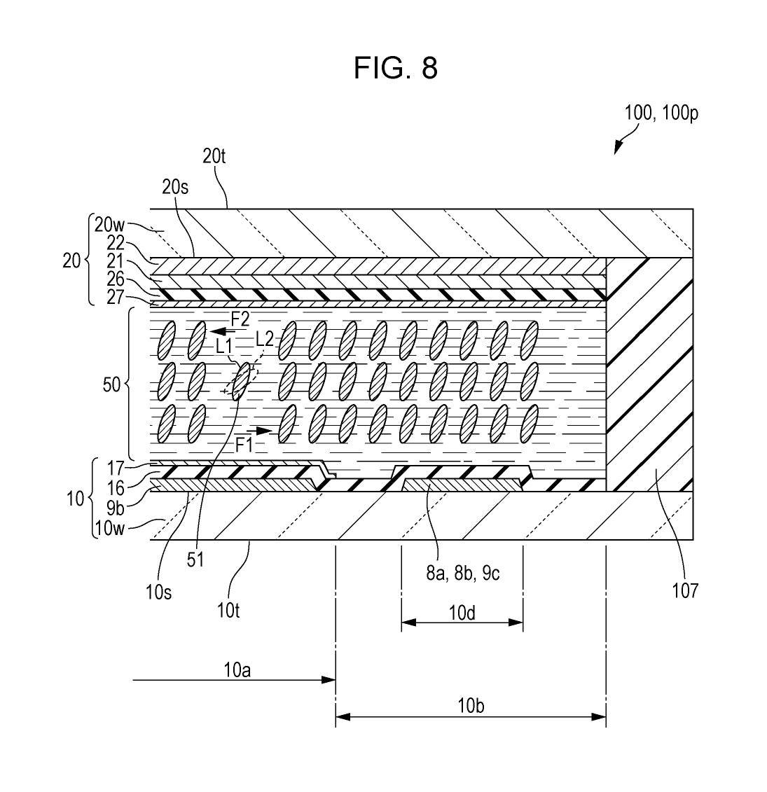

FIG. 8 is a cross-sectional view schematically illustrating components around the peripheral electrode 8a of a liquid crystal device 100 according to a third embodiment of the invention. As illustrated in FIG. 8, in this embodiment, the first substrate 10 has the peripheral electrode 8a in the peripheral region 10b as in the first embodiment. Furthermore, the organic silane compound layers 17 and 27 are respectively disposed on the surfaces of the first and second alignment films 16 and 26 adjacent to the liquid crystal layer 50. Here, the first alignment film 16 is formed in the display region 10a and the peripheral region 10b, but the organic silane compound layer 17 is formed only in the display region 10a and is not formed in the peripheral region 10b. Thus, although the organic silane compound layer 17 is disposed on the surface of the inorganic alignment film (the first alignment film 16) adjacent to the liquid crystal layer 50, the surface of the first substrate 10 adjacent to the liquid crystal layer 50 has higher hydrophilicity at the region 10d overlapping the peripheral electrode 8a in plan view than at the display region 10a. Thus, ionic impurities are attracted to the outside of the display region 10a by the peripheral electrode 8a and allowed to stay there.

The peripheral electrode 8a may be formed of a metal film 8b including copper, silver, gold, platinum, or palladium as a main component. Alternatively, the peripheral electrode 8a may be a conductive film 9b formed at the same time as formation of the pixel electrode 9a.

### Fourth Embodiment

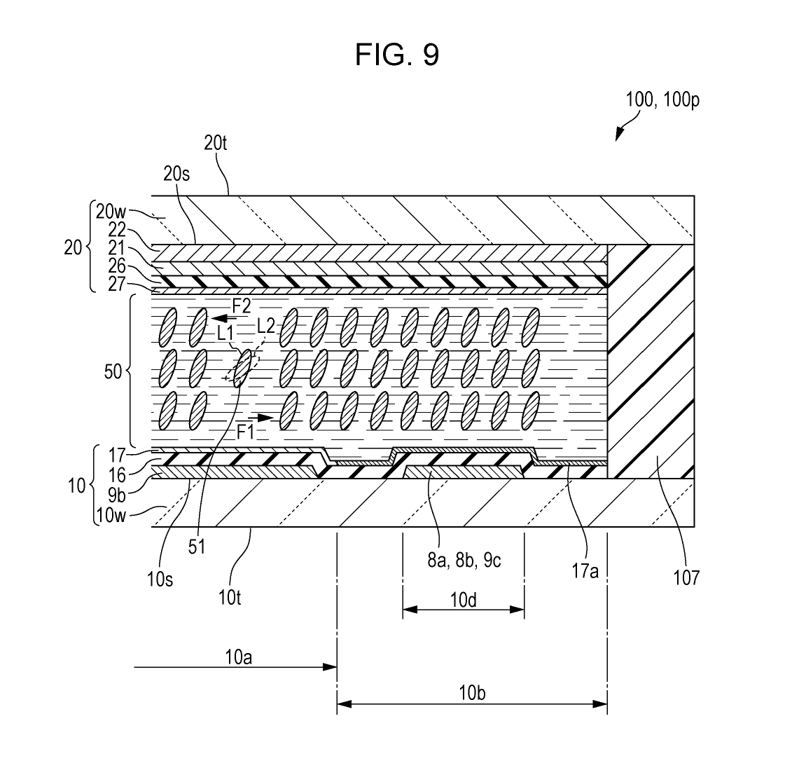

FIG. 9 is a cross-sectional view schematically illustrating components around the peripheral electrode 8a of a liquid crystal device 100 according to a fourth embodiment of the invention. As illustrated in FIG. 9, in this embodiment, the first substrate 10 has the peripheral electrode 8a in the peripheral region 10b as in the first embodiment. Furthermore, the organic silane compound layers 17 and 27 are respectively disposed on the surfaces of the first and second alignment films 16 and 26 adjacent to the liquid crystal layer 50. In this embodiment, the first alignment film 16 and the organic silane compound layer 17 are formed in the display region 10a and the peripheral region 10b. It is to be noted that a portion of the organic silane compound layer 17 in the peripheral region 10b is a modified layer 17a having water-repellent properties lowered by application of energy light, for example. For example, a portion of the organic silane compound layer 17 in the peripheral region 10b has higher hydrophilicity when exposed to energy light such as UV, because the hydrophobic organic functional group R of the organic silane compound layer 17 is disconnected.

Thus, although the organic silane compound layer 17 is disposed on the surface of the inorganic alignment film (the first alignment film 16) adjacent to the liquid crystal layer 50, the surface of the first substrate 10 adjacent to the liquid crystal layer 50 has higher hydrophilicity at the region 10d overlapping the peripheral electrode 8a in plan view than at the display region 10a. Thus, ionic impurities are attracted to the outside of the display region 10a by the peripheral electrode 8a and allowed to stay there.

The peripheral electrode 8a may be formed of a metal film 8b including copper, silver, gold, platinum, or palladium as a main component. Alternatively, the peripheral electrode 8a may be a conductive film 9b formed at the same time as formation of the pixel electrode 9a.

### Other Embodiments

In the above-described embodiments, the invention is applied to the transmission type liquid crystal device 100, but the invention is applicable to a reflection type liquid crystal device 100.

### Example of Application to Electronic Device

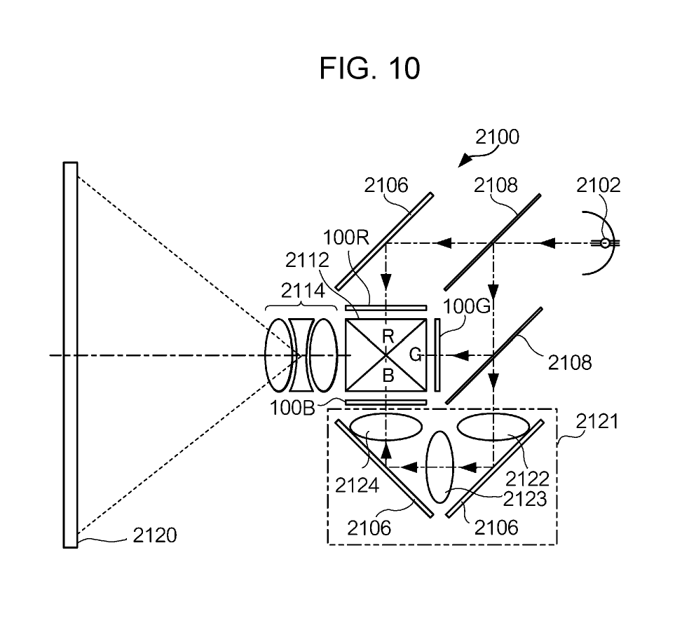

An electronic device including the liquid crystal device 100 according to the above-described embodiment is described. Here, a projection-type display device (a liquid crystal projector) is used as an example of the electronic device according to the invention. FIG. 10 is an explanatory view of a projection-type display device (an electronic device) including the liquid crystal device 100 according to the invention.

A projection-type display device 2100 illustrated in FIG. 10 includes the above-described transmission type liquid crystal devices 100 as light valves. The projection-type display device 2100 includes a lamp unit 2102 (a light source) including a white light source such as a halogen lamp. A projection light from the lamp unit 2102 is separated into three primary colors of red (R), green (G), and blue (B) by three mirrors 2106 and two dichromic mirrors 2108, which are disposed inside the projection-type display device 2100. The separated projection light of the primary colors is introduced to the respective light valves 100R, 100G, and 100B. Since the length of the light path of blue is longer than those of red and green, the blue light is introduced via a relay lens system 2121 including an input lens 2122, a relay lens 2123, and an output lens 2124 so as to prevent the loss.

The projection-type display device 2100 includes three liquid crystal devices including the liquid crystal devices 100 for three colors of red, green, and blue. The light valves 100R, 100G, and 100B have the same configurations as the above-described transmission type liquid crystal device 100. The light modulated by the light valves 100R, 100G, and 100B enters a dichroic prism 2112 from three directions. The red light and the blue light are reflected by the dichroic prism 2112 at 90 degrees, and the green light passes through the dichroic prism 2112. Thus, after synthesizing of images in primary colors, a color image is projected onto a screen 2120 by a projection lens group 2114 (a projection optical system).

### Other Projection-Type Display Devices

The projection-type display device may include LED light sources or the like configured to output red, green, and blue light as light sources. The light from the LED light sources may be applied to different liquid crystal devices.

### Other Electronic Devices

The electronic device to which the liquid crystal device 100 is applied is not limited to the projection-type display device 2100 of the above-described embodiment. The liquid crystal device 100 may be used in other electronic devices, such as a projection-type head-up display (HUD), a direct view head mounted display (HMD), a personal computer, a digital still camera, and a liquid crystal display TV.

The entire disclosure of Japanese Patent Application No. 2017-048370, filed Mar. 14, 2017 is expressly incorporated by reference herein.

What is claimed is:

1. A liquid crystal device comprising:
a first substrate having a pixel electrode in a display region;
a second substrate having a common electrode facing the pixel electrode;
a sealing member connecting the first substrate and the second substrate to each other;
a liquid crystal layer held between the first substrate and the second substrate in a region surrounded by the sealing member;
a peripheral electrode disposed in a peripheral region between the display region of the first substrate and the sealing member; and
an inorganic alignment film covering a surface of the pixel electrode adjacent to the liquid crystal layer, wherein
a surface of the first substrate adjacent to the liquid crystal layer has higher hydrophilicity at a region overlapping the peripheral electrode in plan view than at the display region.

2. The liquid crystal device according to claim 1, further comprising an organic silane compound layer on a surface of the inorganic alignment film adjacent to the liquid crystal layer.

3. The liquid crystal device according to claim 2, wherein the organic silane compound layer is not disposed in the region of the first substrate overlapping the peripheral electrode in plan view.

4. The liquid crystal device according to claim 1, wherein the inorganic alignment film is not disposed in the region of the first substrate overlapping the peripheral electrode in plan view.

5. The liquid crystal device according to claim 1, further comprising a hydrophilized layer on the surface of the first substrate adjacent to the liquid crystal layer in the region overlapping the peripheral electrode in plan view.

6. The liquid crystal device according to claim 5, wherein the hydrophilized layer is disposed on a surface of the peripheral electrode adjacent to the liquid crystal layer.

7. The liquid crystal device according to claim 1, wherein the peripheral electrode and the pixel electrode are formed of different conductive films.

8. The liquid crystal device according to claim 1, wherein the peripheral electrode is formed of a metal film including copper, silver, gold, platinum, or palladium as a main component, and
the hydrophilized layer includes a thiol group bonded to the metal film.

9. The liquid crystal device according to claim 5, wherein the hydrophilized layer includes an anionic hydrophilic group in a surface adjacent to the liquid crystal layer.

10. The liquid crystal device according to claim 5, wherein the hydrophilized layer is not disposed in the display region of the first substrate.

11. The liquid crystal device according to claim 2, wherein the inorganic alignment film and the organic silane compound layer are disposed on the first substrate in the region overlapping the peripheral electrode in plan view, and
a portion of the organic silane compound layer in the region overlapping the peripheral electrode in plan view is a modified layer having lower water-repellent properties.

12. An electronic device comprising the liquid crystal device according to claim 1.

13. An electronic device comprising the liquid crystal device according to claim 2.

14. An electronic device comprising the liquid crystal device according to claim 3.

15. An electronic device comprising the liquid crystal device according to claim 4.

16. An electronic device comprising the liquid crystal device according to claim 5.

17. An electronic device comprising the liquid crystal device according to claim 6.

18. An electronic device comprising the liquid crystal device according to claim 7.

19. An electronic device comprising the liquid crystal device according to claim 8.

20. An electronic device comprising the liquid crystal device according to claim 9.
